(19) United States
(12) Patent Application Publication
(10) Pub. No.: US 2025/0077924 A1
(43) Pub. Date: Mar. 6, 2025

(54) SYSTEMS AND METHODS FOR HYBRID CLASSICAL-QUANTUM OPTIMIZATION USING RANDOM MATRIX THEORY-BASED SUBPROBLEM IDENTIFICATION ON CORRELATION MATRICES

(71) Applicant: JPMORGAN CHASE BANK, N.A., New York, NY (US)

(72) Inventors: Atithi ACHARYA, Piscataway Township, NJ (US); Ruslan SHAYDULIN, New York, NY (US); Shouvanik CHAKRABARTI, Jersey City, NJ (US); Dylan HERMAN, Woodcliff Lake, NJ (US); Pierre MINSSEN, New York, NY (US); Yue SUN, Short Hills, NJ (US); Romina YALOVETZKY, Buenos Aires (AR); Marco PISTOIA, Amawalk, NY (US)

(21) Appl. No.: 18/462,187

(22) Filed: Sep. 6, 2023

(51) Int. Cl. G06N 10/40

(52) U.S. Cl. CPC G06N 10/40; G06N 10/60

(57) ABSTRACT

Systems and methods for hybrid classical-quantum optimization using random matrix theory-based subproblem identification on correlation matrices are disclosed. A method may include a classical computer program: receiving a problem to optimize and time series data comprising a plurality of parameters; computing an average and a correlation matrix for the time series data; determining an aspect ratio for the correlation matrix; filtering the correlation matrix based on the aspect ratio and using a denoising solution; redefining the problem into a plurality of subproblems; determining that one of the plurality of subproblems exceeds a limit of a quantum computer; repeatedly dividing the subproblem until the limit of the quantum computer is met; embedding the subproblems on the quantum computer, wherein the quantum computer is configured to execute a quantum optimization routine on each of the subproblems and output a plurality of solution vectors; and recombining the plurality of solution vectors.

### BACKGROUND OF THE INVENTION

### 1. Field of the Invention

Embodiments relate to systems and methods for hybrid classical-quantum optimization using random matrix theory-based subproblem identification on correlation matrices.

### 2. Description of the Related Art

Classical solvers for optimizations, such as portfolio optimizations, are often run based on algorithms such as Branch-and-Cut. Recently, it has been shown that quantum algorithms can provide quadratic speedup not only in the worst case but also generalized to every instance. Near-term quantum computers, however, come with limited number of qubits and/or limited connectivity. This poses a challenge in demonstrating speedups in optimizations of practical importance.

### SUMMARY OF THE INVENTION

Systems and methods for hybrid classical-quantum optimization using random matrix theory-based subproblem identification on correlation matrices are disclosed. In one embodiment, a method for hybrid classical-quantum optimization may include: (1) receiving, by a classical computer program, a problem to optimize and time series data comprising a plurality of parameters; (2) computing, by the classical computer program, an average and a correlation matrix for the time series data; (3) determining, by the classical computer program, an aspect ratio for the correlation matrix; (4) filtering, by the classical computer program, the correlation matrix based on the aspect ratio and using a denoising solution; (5) redefining, by the classical computer program, the problem into a plurality of subproblems; (6) determining, by the classical computer program, that one of the plurality of subproblems exceeds a limit of a quantum computer; (7) repeatedly dividing, by the classical computer program, the subproblem until the limit of the quantum computer is met; (8) embedding, by the classical computer program, the subproblems on the quantum computer, wherein the quantum computer is configured to execute a quantum optimization routine on each of the subproblems and output a plurality of solution vectors; and (9) recombining, by the classical computer program, the plurality of solution vectors.

In one embodiment, the denoising solution may include eigenvalue filtering.

In one embodiment, the filtering generates a plurality of filtered correlation matrices, with a first filtered correlation matrix to random noise, a second filtered correlation matrix carrying a macroscopic structure, and a third filtered correlation matrix corresponds to a highest eigen-projector.

In one embodiment, the method may also include: determining, by the classical computer program, that there are a plurality of communities in the correlation matrix and that the correlation matrix can decompose; and identifying, by the classical computer program, the plurality of communities in the correlation matrix.

In one embodiment, the determination there are a plurality of communities may be based on a modularity score.

In one embodiment, the classical computer program redefines the problem into the plurality of subproblems by mapping constraints of the problem into the plurality of subproblems.

In one embodiment, the limit of the quantum computer may include a number of qubits used in the quantum computer.

In one embodiment, the quantum optimization routine may include the Quantum Approximate Optimization Algorithm or a quantum annealing algorithm.

According to another embodiment, a system may include: a classical computer executing a classical computer program; and a quantum computer in communication with the classical computer program. The classical computer program receives a problem to optimize and time series data comprising a plurality of parameters; the classical computer program computes an average and a correlation matrix for the time series data; the classical computer program determines an aspect ratio for the correlation matrix; the classical computer program filters the correlation matrix based on the aspect ratio and using a denoising solution; the classical computer program redefines the problem into a plurality of subproblems; the classical computer program determines that one of the plurality of subproblems exceeds a limit of a quantum computer; the classical computer program repeatedly divides the subproblem until the limit of the quantum computer is met; the classical computer program embeds the subproblems on the quantum computer; the quantum computer executes a quantum optimization routine on each of the subproblems and output a plurality of solution vectors; and the classical computer program recombines the plurality of solution vectors.

In one embodiment, the denoising solution may include eigenvalue filtering.

In one embodiment, the filtering generates a plurality of filtered correlation matrices, with a first filtered correlation matrix to random noise, a second filtered correlation matrix carrying a macroscopic structure, and a third filtered correlation matrix corresponds to a highest eigen-projector.

In one embodiment, the classical computer program determines that there are a plurality of communities in the correlation matrix and that the correlation matrix can decompose; and the classical computer program identifies the plurality of communities in the correlation matrix.

In one embodiment, the determination there are a plurality of communities may be based on a modularity score.

In one embodiment, the classical computer program redefines the problem into the plurality of subproblems by mapping constraints of the problem into the plurality of subproblems.

In one embodiment, the limit of the quantum computer may include a number of qubits used in the quantum computer.

In one embodiment, the quantum optimization routine may include the Quantum Approximate Optimization Algorithm or a quantum annealing algorithm.

In one embodiment, a non-transitory computer readable storage medium, may include instructions stored thereon, which when read and executed by one or more computer processors, cause the one or more computer processors to perform steps comprising: receiving a problem to optimize and time series data comprising a plurality of parameters; computing an average and a correlation matrix for the time series data; determining an aspect ratio for the correlation matrix; filtering the correlation matrix based on the aspect ratio and using a denoising solution; determining, based on a modularity score, that there are a plurality of communities in the correlation matrix and that the correlation matrix can decompose; identifying the plurality of communities in the correlation matrix; redefining the problem into a plurality of subproblems by mapping constraints of the problem into the plurality of subproblems; determining that one of the plurality of subproblems exceeds a limit of a quantum computer; repeatedly dividing the subproblem until the limit of the quantum computer is met; embedding the subproblems on the quantum computer; receiving a plurality of solution vectors from the quantum computer; and recombining the plurality of solution vectors.

In one embodiment, the denoising solution may include eigenvalue filtering.

In one embodiment, the filtering generates a plurality of filtered correlation matrices, with a first filtered correlation matrix to random noise, a second filtered correlation matrix carrying a macroscopic structure, and a third filtered correlation matrix corresponds to a highest eigen-projector.

In one embodiment, the limit of the quantum computer may include a number of qubits used in the quantum computer.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for hybrid classical-quantum optimization using random matrix theory-based subproblem identification on correlation matrices according to an embodiment;

FIGS. 2A and 2B illustrate a method for hybrid classical-quantum optimization using random matrix theory-based subproblem identification on correlation matrices according to an embodiment;

FIG. 3 depicts an exemplary computing system for implementing aspects of the present disclosure.

### DETAILED DESCRIPTION OF PREFERRED EMBODIMENTS

Embodiments relate to systems and methods for hybrid classical-quantum optimization using random matrix theory-based subproblem identification on correlation matrices.

Embodiments may use a three step process. The first step may identify highly correlated groups whose members are strongly correlated while they are anticorrelated across the groups. Embodiments may use random matrix theory (RMT)-based community detection algorithms that work using the underpinnings of RMT. Such algorithms exploit the typical eigen-structure (C=C₁+C₂+C₃) and then run community detection algorithms with modified-modularity maximization schemes.

Next, once the communities are identified, embodiments may rewrite the objective functions for each subproblem with appropriate constraint satisfaction. For example, cardinality constraints may be redistributed according to size (e.g., the number of nodes) or volume of communities (e.g., the sum of edge weights). Then, the subproblems may be mapped and encoded onto a quantum computer. Quantum optimization algorithms, such as the Quantum Approximate Optimization Algorithm (QAOA) or Quantum annealing routines, may be run to obtain solution vectors for each subproblem.

The solution vectors may then be recombined, and the full-size objective function may be recomputed in order to evaluate solution quality. Similarity measures (such as Jaccard similarity in the example of binary variables) may be used for the direct comparison of solution vectors.

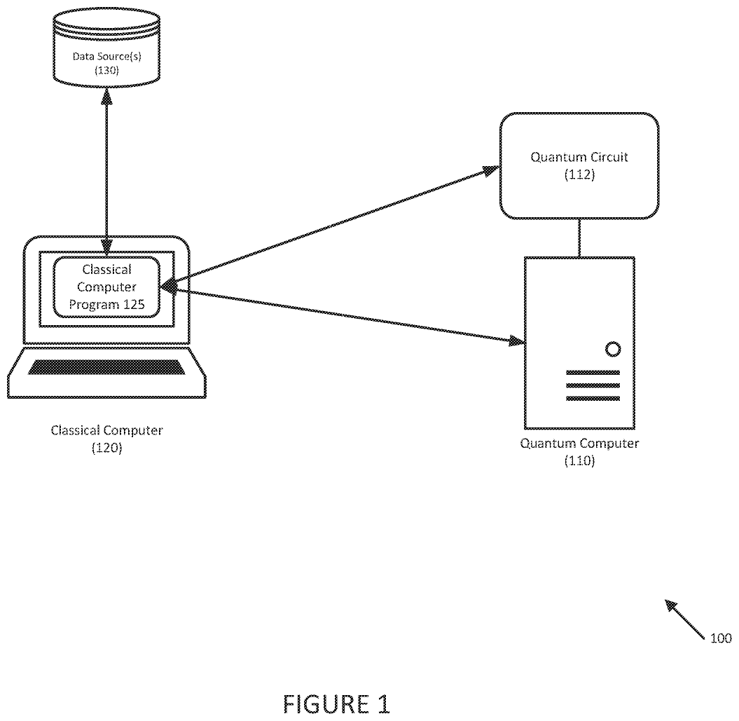

Referring to FIG. 1, a system for hybrid classical-quantum optimization using random matrix theory-based subproblem identification on correlation matrices is disclosed according to an embodiment. System 100 may include quantum computer 110 that may execute quantum circuit 112. Quantum computer 110 may be a device that performs quantum computations, such as those based on the collective properties of quantum states including superposition, interference, and entanglement.

Classical computer 120 may be any suitable general purpose computing device, including servers, workstations, desktop, notebook, laptop, or tablet computers, etc. For example, classical computer 120 may be a microprocessor-based device. Classical computer 120 may interface with quantum circuit 112 using classical computer program 125, which may provide input to, and receive output from, quantum computer 110. In one embodiment, classical computer program 125 may generate one or more quantum circuits 112, may transpile the quantum circuit(s) 112 to machine-readable instructions, and may then send the transpiled circuit(s) 112 to quantum computer 110 for execution. Classical computer program 125 may also receive the results of the execution of the one or more quantum circuits 112.

Data source(s) 130 may include one or more sources of data. For example, data source(s) 130 may provide input data, such as time series data. Examples of time series data may include equity pricing data, fixed income asset data, temporal interactions between users (e.g., used for online behavior analysis, to identify clusters of users who engage similarly, etc.), etc.

In one embodiment, the input data may have a plurality of parameters. For equities or fixed income data, the parameters may include a number of assets, returns per asset, and time horizons (e.g., time periods).

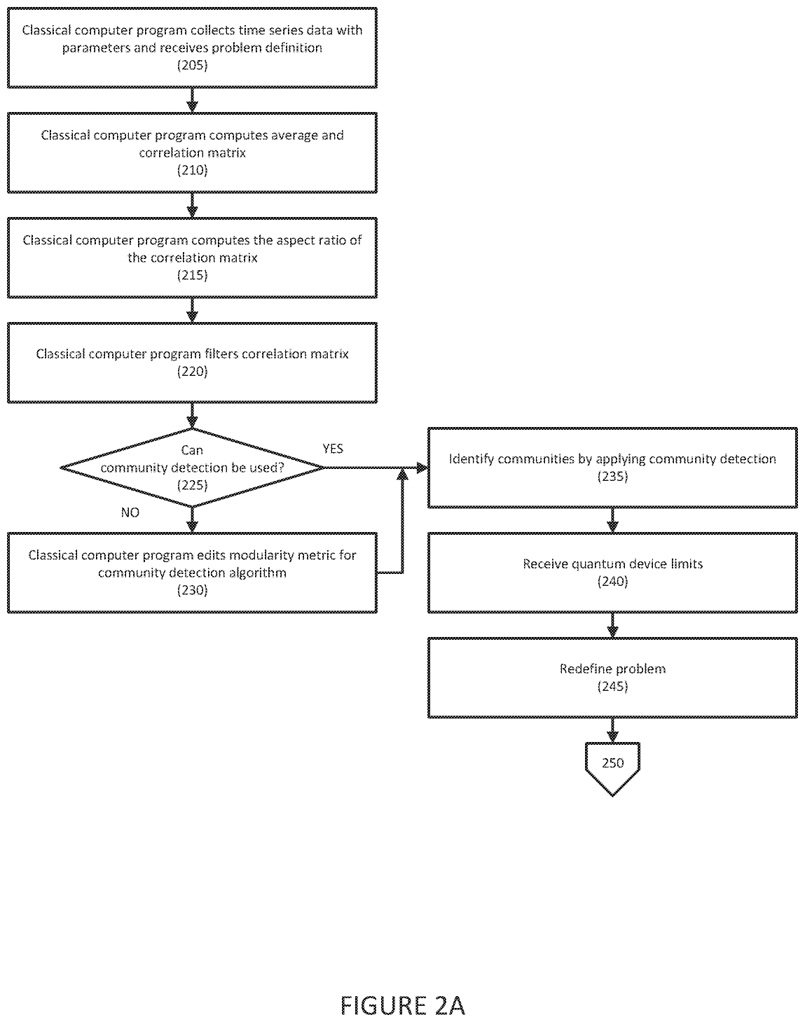

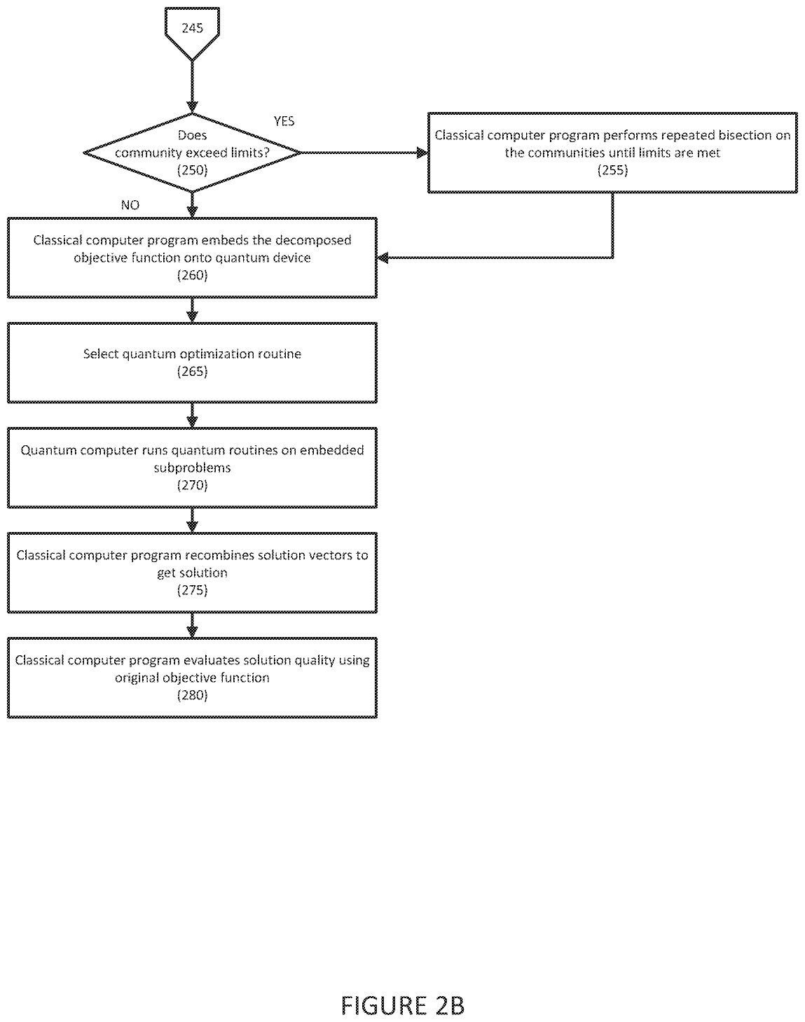

Referring to FIGS. 2A and 2B, a method for hybrid classical-quantum optimization using random matrix theory-based subproblem identification on correlation matrices is disclosed according to an embodiment.

In step 205, a classical computer program may collect time series data and a definition of the problem to optimize. The time series data may include a plurality of parameters. For example, for a financial optimization problem, the time series data may be for assets, such as equities or fixed income, and the parameters may be a number of assets (N) and a time horizon (T).

The problem definition may be in terms of the assets and metrics inferred from the data, such as the averages and a correlation matrix. Other inputs may be used to define the problem, such as the sector of an asset and constants (e.g., maximize; Σᵢ xᵢ rᵢ+qΣᵢⱼ xᵢⱼ Cᵢⱼ such that we select only B assets and K assets from a specific sector, with rᵢ the averages, Cᵢⱼ the correlations and q, B and K input constants), etc.

In step 210, the classical computer program may compute an average and a correlation matrix. For example, the computer program may compute average returns (i.e., average over time) r and correlation matrices C. Each element in the correlation matrices C may be computed by computing the covariance between the random variable (e.g., corresponding to row index), and the random variable (e.g., corresponding to the column index), and then normalizing the covariance with their individual variances.

In step 215, the classical computer program may determine the aspect ratio—the number of assets collected over the time horizon—of the correlation matrix. Based on the aspect ratio, random matrix theory may be used to filter the correlation matrices C. An example of filtering is disclosed in V. A. Marcenko and L. A. Pastur, “Distribution Of Eigenvalues For Some Sets Of Random Matrices,” Mathematics of the USSR-Sbornik, Vol. 1 (4), pp 457-483 (1967), the disclosure of which is hereby incorporated, by reference, in its entirety. The filtered correlation matrix may then be used for the rest of the algorithm.

In step 220, based on the value of the aspect value, the computer program may select an appropriate solution for denoising the data (e.g. removing random noise from the data), and may filter the data with the solution. Examples of solutions may include eigenvalue filtering. Examples of such solutions are described in V. A. Marcenko and L. A. Pastur, “Distribution Of Eigenvalues For Some Sets Of Random Matrices”, Mathematics of the USSR-Sbornik, Vol. 1 (4), pp 457-483 (1967), the disclosure of which is hereby incorporated, by reference, in its entirety.

For example, the classical computer program may receive the aspect ratio and the correlation matrices C as the parameters, and may generate filtered correlation matrices C₁, C₂, and C₃ corresponding to the input correlation matrix. C₁ is the part of the correlation matrix related to random noise. The eigenvalue distribution follows the Marchenko-Pastur distribution (the aspect ratio may be used to define its support). C₂ is the intermediate part of the market correlation matrix that carries a macroscopic structure, and is used as the correlation matrix C going forward unless specified otherwise. C₃ is the market mode or the part corresponding to the highest eigen-projector.

In step 225, the computer program may determine if community detection can be used on the correlation matrix C. Communities are groups with high correlation within-them and low correlation with other groups. Communities may be inferred based on the clustering methods in the correlation matrix C.

In one embodiment, the computer program may determine if there is more than one community, and if the correlation matrix Cdecomposes (e.g., that the correlation matrix C decomposes into C₁, C₂, and C₃ using matrix decomposition), embodiments may use a community detection algorithm to determine a modularity score. If the modularity score increases, when the assets may be partitioned into more than one community, indicating that the correlation matrix C includes more than one community.

An example of a community detection algorithm and a modularity score is disclosed in M. E. J. Newman and M. Girvan, “Finding and evaluating community structure in networks”, Phys. Rev. E 69, 026113 (26 Feb. 2004), the disclosure of which is hereby incorporated, by reference, in its entirety.

If community detection cannot be used (e.g., if the communities detected are only of very different sizes, like few huge communities and the rest are very small ones), in step 230, the classical computer program may edit the modularity metric used in the community detection algorithm. For example, for σ mapping asset to communities, the new metric may be defined as (1/Cₙₒᵣₘ) ΣᵢⱼC₂^{(ij)}δ(σᵢσⱼ), with Cₙₒᵣₘ being the sum of all elements of the original correlation matrix, C₂^{(ij)} being the denoised correlation of assets i and j, and δ(σᵢ,σⱼ) being equal to 1 if i and j are part of the same community following the mapping σ, otherwise 0. An example of the null hypothesis and a modified community detection algorithm is disclosed in Mel MacMahon and Diego Garlaschelli, “Community Detection for Correlation Matrices,” Phys. Rev. X 5, 021006 (2015), the disclosure of which is hereby incorporated, by reference, in its entirety. The modularity metric may ensure that there are high (positive) correlations within each community but low (negative) correlations across members of different communities. The metric is suitable for correlation matrices and is compatible with the findings of random matrix theory. The algorithm generates an optimal number of communities and their members. In one embodiment, the optimal number of communities is obtained when there is no further gain in the modularity metric. The members of these communities are the assets. If one asset is moved from one community to another, this will decrease the modularity score since the assignment was already optimal.

If community detection is available, in step 235, the classical computer program may identify the communities in C using community detection. In one embodiment, the classical computer program may match each asset in the correlation matrix C to an asset in one of the communities. For example, the community detection algorithm may return a list of communities from C.

In step 240, the classical computer program may receive quantum computer limits. For example, the classical computer program may receive quantum computer specifications, such as the number of qubits used in the quantum computer.

In step 245, the classical computer program may redefine the problem into a plurality of subproblems. The subproblems that represent the original problem may be restricted to only the assets within the communities. This implies a redefinition of the cost function and constraints.

In one embodiment, the classical computer program may map the constraints of the original problem to the subproblems.

For example, a solution is said to be valid if it satisfies the original problem constraints. For constraint on a single variables, or variables within the same communities, the constraint is by definition the same in the subproblem. As such, if a sub-solution is valid, it will also be the case in the original problem.

For linear constraints on variables within multiples communities, in the case covered if for all subproblems the redefined original constraint is fulfilled then τᵢ xᵢwᵢ=C. Therefore, the original constraint is satisfied.

If all variables in a subproblem are to be integer, the sub-constraint 1 might not be feasible. In this case, rounding techniques can be used to overcome this issue. For example, if the original constraint, x₁+x₂+x₃=10, the community detection may isolate all three variables, as such x₁=10/3, x₂=10/3, x₃=10/3. If x; are integer, this is unfeasible, but the decomposition procedure may be modified by rounding and ensuring the validity of the final constraint, x₁=round (10/3)=3, x₂=round (10/3)=3, x₃=10-3*2=4. In the financial setting, this issue arises in the case of a cardinally constraint.

The objective function may be simplified to take as input only variables from within the communities, while the other variables may be set to a default value (e.g., 0). The constraint on a single variable is directly mappable, so no changes are required during the redefinition of the problem.

In step 250, the classical computer program may determine if the subproblem exceeds the quantum computer limits, such as does the size of the largest community exceed the maximum number of qubits of the quantum computer. For example, characteristics of the subproblem, such as the number of variables, exceed the number of qubits in the quantum computer, connectivity of the quantum hardware, etc., the subproblem cannot be encoded on the quantum computer.

If the subproblem does exceed the quantum computer limits, in step 255, the classical computer program may perform repeated divisions on the subproblem until limits are met. For example, the classical computer program may start with the largest subproblem until the limitations of the quantum computer are met.

If the subproblem does not exceed the quantum computer limits, in step 260 the classical computer program may embed the decomposed objective function (i.e., the objective function of the original problem that is decomposed for one of the communities) onto the quantum computer. For example, the classical computer program may redistribute the constraints across communities.

In one embodiment, there may be only one decomposed objective function per community.

In step 265, the classical computer program may select a quantum optimization routine, such as QAOA, and in step 270, the quantum computer may run the quantum optimization routine on the embedded subproblems, and may return solution vectors to the classical computer program.

In step 275, the classical computer program may recombine the solution vectors, resulting in a solution. In one embodiment, the solution of each sub-problem may be appended together. For example, each sub-problem returns a solution for its assets, and the full solution is the full list of solutions from every subproblem. Because the communities do not overlap (e.g., there are no assets in more than one community), the solutions may simply be appended together. In step 280, the classical computer program may evaluate the solution quality using original objective function.

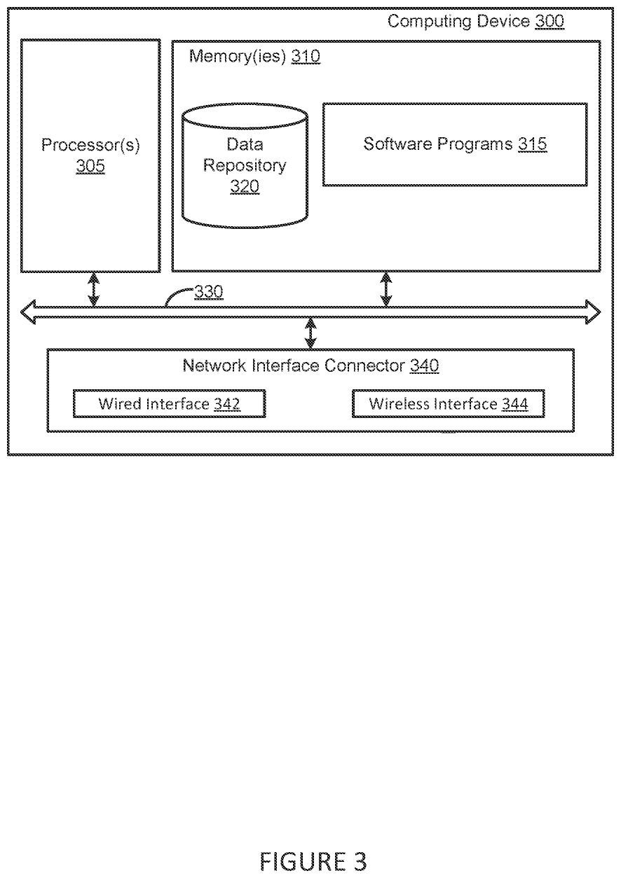

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for hybrid classical-quantum optimization, comprising:
receiving, by a classical computer program, a problem to optimize and time series data comprising a plurality of parameters;
computing, by the classical computer program, an average and a correlation matrix for the time series data;
determining, by the classical computer program, an aspect ratio for the correlation matrix;
filtering, by the classical computer program, the correlation matrix based on the aspect ratio and using a denoising solution;
redefining, by the classical computer program, the problem into a plurality of subproblems;
determining, by the classical computer program, that one of the plurality of subproblems exceeds a limit of a quantum computer;
repeatedly dividing, by the classical computer program, the subproblem until the limit of the quantum computer is met;
embedding, by the classical computer program, the subproblems on the quantum computer, wherein the quantum computer is configured to execute a quantum optimization routine on each of the subproblems and output a plurality of solution vectors; and
recombining, by the classical computer program, the plurality of solution vectors.

2. The method of claim 1, wherein the denoising solution comprises eigenvalue filtering.

3. The method of claim 1, wherein the filtering generates a plurality of filtered correlation matrices, with a first filtered correlation matrix to random noise, a second filtered correlation matrix carrying a macroscopic structure, and a third filtered correlation matrix corresponds to a highest eigen-projector.

4. The method of claim 1, further comprising:
determining, by the classical computer program, that there are a plurality of communities in the correlation matrix and that the correlation matrix can decompose; and
identifying, by the classical computer program, the plurality of communities in the correlation matrix.

5. The method of claim 4, wherein the determination there are a plurality of communities is based on a modularity score.

6. The method of claim 1, wherein the classical computer program redefines the problem into the plurality of subproblems by mapping constraints of the problem into the plurality of subproblems.

7. The method of claim 1, wherein the limit of the quantum computer comprises a number of qubits used in the quantum computer.

8. The method of claim 1, wherein the quantum optimization routine comprises the Quantum Approximate Optimization Algorithm or a quantum annealing algorithm.

9. A system, comprising:
a classical computer executing a classical computer program; and
a quantum computer in communication with the classical computer program;
wherein:
the classical computer program receives a problem to optimize and time series data comprising a plurality of parameters;
the classical computer program computes an average and a correlation matrix for the time series data;
the classical computer program determines an aspect ratio for the correlation matrix;
the classical computer program filters the correlation matrix based on the aspect ratio and using a denoising solution;
the classical computer program redefines the problem into a plurality of subproblems;
the classical computer program determines that one of the plurality of subproblems exceeds a limit of a quantum computer;
the classical computer program repeatedly divides the subproblem until the limit of the quantum computer is met;
the classical computer program embeds the subproblems on the quantum computer;
the quantum computer executes a quantum optimization routine on each of the subproblems and output a plurality of solution vectors; and
the classical computer program recombines the plurality of solution vectors.

10. The system of claim 9, wherein the denoising solution comprises eigenvalue filtering.

11. The system of claim 9, wherein the filtering generates a plurality of filtered correlation matrices, with a first filtered correlation matrix to random noise, a second filtered correlation matrix carrying a macroscopic structure, and a third filtered correlation matrix corresponds to a highest eigen-projector.

12. The system of claim 9, wherein:
the classical computer program determines that there are a plurality of communities in the correlation matrix and that the correlation matrix can decompose; and
the classical computer program identifies the plurality of communities in the correlation matrix.

13. The system of claim 12, wherein the determination there are a plurality of communities is based on a modularity score.

14. The system of claim 9, wherein the classical computer program redefines the problem into the plurality of subproblems by mapping constraints of the problem into the plurality of subproblems.

15. The system of claim 9, wherein the limit of the quantum computer comprises a number of qubits used in the quantum computer.

16. The system of claim 9, wherein the quantum optimization routine comprises the Quantum Approximate Optimization Algorithm or a quantum annealing algorithm.

17. A non-transitory computer readable storage medium, including instructions stored thereon, which when read and executed by one or more computer processors, cause the one or more computer processors to perform steps comprising:
receiving a problem to optimize and time series data comprising a plurality of parameters;
computing an average and a correlation matrix for the time series data;
determining an aspect ratio for the correlation matrix;
filtering the correlation matrix based on the aspect ratio and using a denoising solution;
determining, based on a modularity score, that there are a plurality of communities in the correlation matrix and that the correlation matrix can decompose;
identifying the plurality of communities in the correlation matrix;
redefining the problem into a plurality of subproblems by mapping constraints of the problem into the plurality of subproblems;
determining that one of the plurality of subproblems exceeds a limit of a quantum computer;
repeatedly dividing the subproblem until the limit of the quantum computer is met;
embedding the subproblems on the quantum computer;
receiving a plurality of solution vectors from the quantum computer; and
recombining the plurality of solution vectors.

18. The non-transitory computer readable storage medium of claim 17, wherein the denoising solution comprises eigenvalue filtering.

19. The non-transitory computer readable storage medium of claim 17, wherein the filtering generates a plurality of filtered correlation matrices, with a first filtered correlation matrix to random noise, a second filtered correlation matrix carrying a macroscopic structure, and a third filtered correlation matrix corresponds to a highest eigen-projector.

20. The non-transitory computer readable storage medium of claim 17, wherein the limit of the quantum computer comprises a number of qubits used in the quantum computer.
